(19) United States
(12) Patent Application Publication
(10) Pub. No.: US 2008/0103875 A1
(43) Pub. Date: May 1, 2008

(54) Methods and systems for an interactive data finder

(76) Inventors: Michael Kokernak, Boston, MA (US); Madeleine Noland, Quincy, MA (US); Jason Toy, Concord, NH (US); Jiongye Li, Quincy, MA (US); Tobias Burress, Boston, MA (US); Christopher McClelland, Marblehead, MA (US); Jonathan Katz, Dobbs Ferry, NY (US); Andrew Mione, Roxbury Crossing, MA (US); Brian Mitchell, Boston, MA (US); Jason Newton, N. Chelmsford, MA (US); Michael Rosa, Boston, MA (US); Brian Sinnett, Cambridge, MA (US)

Correspondence Address: ROPES & GRAY LLP, PATENT DOCKETING 39/41, ONE INTERNATIONAL PLACE, BOSTON, MA, 02110-2624, US

(21) Appl. No.: 11/590,355

(22) Filed: Oct. 31, 2006

(51) Int. Cl. G06F 17/30

(52) U.S. Cl. 705/10

(57) ABSTRACT

The systems and methods disclosed herein include an interactive data finder that allows an advertisement purchaser to associate media programs with demographics and subscriber information. The data finder comprise a search module for processing input data to determine data representative of media buying opportunities as a function of search options, where the search options are representative of media buying criteria. The data finder also comprises a category module for refining the data representative of the media buying opportunities as a function of filter options, where the filter options are representative of media buying criteria related to the media buying opportunities. The refined data provides the advertisement purchaser with the information that associates the media-buying opportunities with at least one of the demographics and the subscriber information.

### FIELD OF THE INVENTION

The systems and methods described herein generally pertain to the field of media advertising. More particularly, these systems and methods pertain to an interactive data finder for determining media-buying opportunities associated with demographics, subscriber and program information.

### BACKGROUND

Traditional approaches to purchasing TV advertisement are under close scrutiny due to a dramatic increase in the number of television channels across a variety of media platforms. This expansion in channel capacities has created an array of rich and varied media-buying opportunities for today's advertisers. Moreover, the complex nature of today's media campaigns requires advertising dollars to be accountable so as to eliminate ineffectual spending. As such there exists a need for systems and methods that will facilitate the purchase of advertising opportunities.

### SUMMARY

The systems and methods described herein include, among other things, a web-based interactive data finder. This data finder determines media-buying opportunities by performing targeted searches of information at multiple drill-down levels and in multiple data categories.

In one aspect, the interactive data finder is a piece of software that provides a client, such as an advertisement purchaser, with desired media-buying information using one or more media-buying criteria input by the client. The data finder includes several functional modules that conduct information searches at a designated drill-down level or in a specific data category using at least one of the media-buying criteria. More specifically, the data finder includes a search module for processing input data to determine data representative of media buying opportunities as a function of one or more search options. These search options are representative of the media buying criteria supplied by the client. The data finder also includes a category module for refining the data obtained from the search module as a function of user-selectable filter options, where the filter options are representative of media buying criteria related to the media buying opportunities. The refined data from the category module is associated with a combination of demographics, subscriber and program information. The data finder further includes a media-content module for presenting additional in-depth information regarding a portion of the refined data from the category module that is representative of one of the media buying opportunities.

In one embodiment, the interactive data finder further includes a data parsing structure for receiving the input data from multiple media sources, identifying multiple categories for classifying the input data, and editing the input data to include information related to the categories, where the input data includes at least one of Program Guide, subscriber, and demographics information. The edited data offers the client more granular information about the media buying opportunities than the input data from the media sources.

In one embodiment, the various categories comprise a designated market category that includes data representative of at least one designated market area, a media platform category that includes data representative of at least one media platform, a media program category that includes data representative of at least one media program, and a cable system category that includes data representative of at least one cable system.

In one embodiment, the search module searches the input data in the multiple categories by applying search options that are customized with regard to at least one of the categories. The category module further refines the data obtained from the search module by applying the filter options also customized to at least one of the categories. The media-content module presents additional data regarding the portion of refined data determined from the category module that is representative of one of the media buying opportunities. This additional data is adapted to be an aggregate of data culled from one or more of the categories.

In one embodiment, the data parsing structure further includes a tracking element for logging a movement of media content among multiple channel positions and between analog and digital delivery systems revealed in the input data.

In one embodiment, the data parsing structure extracts data representative of paid programming from the input data and classifies the extracted data into types including a shopping programming type, a paid religious programming type, a religious programming type, and a regular paid programming type. The data parsing structure can further parse data in each of the categories into sub-categories that are associated with respective ones the categories. The data parsing structure then edits the data in the sub-categories to include information related to the respective categories and sub-categories. For example, the data parsing structure is able to parse data in the media platform category and classify the parsed data into sub-categories representative of digital media platforms, analog media platforms, Pacific-feed media platforms, Eastern-feed media platforms, and other multi-feed media platforms.

In one embodiment, the media content module, provided from a media content interface of the data finder, is accessible from at least one of a category interface and a landing interface of the data finder, where the category interface presents the category module in connection with its associated filter options. In addition, the landing interface presents a portion of the search module that comprises of a basic search engine. An advanced search engine of the search module is presented from a search interface of the data finder.

In one embodiment, the landing interface of the data finder, in addition to the basic search engine, further includes a graph module for presenting color-coded plots of a first portion of the input data and a table module for presenting a second portion of the input data, where both the first and second data portions are functions of a time period selectable by the client.

In one embodiment, the graph module presents color-coded program airtime plots, over the selected time period, associated with the first data portion, where this first data portion is representative of media-buying opportunities categorized according to at least one of a program genre and programming type. The second data portion, presented via the table module, is representative of media-buying opportunities sharing a common theme, where the theme comprises one of a designated market areas theme, a TV actor appearances theme, a media programs theme, and a media genres theme. More particularly, the second data portion is ordered in the table according to program airtime corresponding to the respective media-buying opportunities represented by the second data portion.

In one embodiment, the category interface also displays the data representative of the media buying opportunities determined from the search module, and this data is adapted to change in real time in response to a particular selection of the filter options made by the client.

In one embodiment, the search options and the filter options are tailored to the designated market area category and specify at least one of a geographical profile, a demographics profile, a rank, and a name associated with the designated area category.

In one embodiment, the search options and the filter options are tailored to the media program category and specify at least one of a program profile, actor information, a network affiliation, a paid programming type, and a syndication criterion associated with the media program category.

In one embodiment, the search options and the filter options are tailored to the media platform category and specify at least one of a call sign, a network affiliation, a type, a channel number, a program name, a geographical profile, and a designated market area profile associated with the media platform category.

In one embodiment, the search options and the filter options are tailored to the cable system category and specify at least one of a cable system profile, a designated market area profile, and a geographical profile associated with the cable system category.

In one embodiment, the data in the media content module that is representative of one of the media buying opportunities is a function of a time period customizable by the client. This media buying opportunity relates to one of a designated market area, a media program, a media platform, a cable system, a program genre, and an actor appearance.

In one embodiment, the media buying opportunity relates to the designated market area, the corresponding media content module includes a customizable map showing at least a portion of the designated market area, and the data representative of the media buying opportunity identifies at least one of a cable provider, a satellite provider and a media platform in the designated market area.

In one embodiment, the media buying opportunity relates to the media platform, the corresponding media content module includes multiple color-coded plots of program airtime in multiple paid programming categories of the media platform, and the data representative of the media buying opportunity is organized in a program schedule format associated with the media platform. More specifically, the program schedule format includes multiple rows corresponding to time blocks, multiple columns corresponding to calendar days within the selected time period, and multiple cells each corresponding to a program scheduled in one of the times blocks and on one of the calendar days. The time blocks are color-coded by day parts, and at least one of the program cells is color-coded according to a paid programming type of the program associated with the program cell. The media content module also includes an indicator element for indicating a trend in distribution for at least one of the media platform and a program associated with the media platform among various channel positions, geographical locations, analog and digital delivery systems, and cable providers and subscribers of the platform. Furthermore, the indicator element may also indicate a trend in a total number of times programs of a certain paid programming type are aired via the media platform.

In one embodiment, the media buying opportunity relates to the media program, the corresponding media content module includes a plot of a number of times the media program is aired within the selected time period, and the data representative of the media buying opportunity identifies a genre of the program, a language of the program, at least one actor in the program, at least one credit in the program, at least one episode of the program, and at least one media platform airing the program.

In one embodiment, the media buying opportunity relates to the actor, the corresponding media content module includes a plot of a number of appearances the actor has made within the selected time period, and the data representative of the media buying opportunity is associated with a media program featuring the actor that is aired within the time period.

In one embodiment, the media buying opportunity relates to the program genre, the data representative of the media buying opportunity is associated with a media program belonging to the program genre that is aired within the selected time period, and the corresponding media content module includes a plot of a number of times programs in the media genre is aired within the time period.

In one embodiment, the media buying opportunity relates to a system, the corresponding media content module includes multiple color-coded plots of program airtime in multiple paid programming categories of the system, and the data representative of the media buying opportunity includes at least one of a program schedule, a number of subscribers, and at least one DMA associated with the system. In addition, the system comprises one of a cable system and a satellite system. Moreover, time blocks of the program schedule are color-coded by day parts.

In one embodiment, the data finder further includes multiple media-content interfaces having data representative of respective ones of media buying opportunities, where the media content interfaces are accessible from at least one of the loading and category interfaces, and at one of the media content interfaces is accessible from at least another one of the media content interfaces.

### BRIEF DESCRIPTION OF THE DRAWINGS

These and other features and advantages will be more fully understood by the following illustrative description with reference to the appended drawings, in which like elements are labeled with like reference designations, and in which the drawings may not be drawn to scale.

FIG. 1 illustrates an embodiment of an interactive data finder of the invention.

FIG. 2 illustrates a front-end component of the embodiment shown in FIG. 1.

FIG. 3 illustrates certain web-based interfaces in the embodiment shown in FIG. 1.

FIG. 4 illustrates a landing interface of the interfaces shown in FIG. 3.

FIG. 5 illustrates a drill-down interface of the interfaces shown in FIG. 3.

FIG. 6 illustrates a search interface of the interfaces shown in FIG. 3, customized to perform searches of designated market areas (DMA's).

FIG. 7 illustrates another embodiment of the search interface shown in FIG. 6, customized to perform searches of media platforms.

FIG. 8 illustrates another embodiment of the search interface shown in FIG. 6, customized to perform searches of media programs.

FIG. 9 illustrates another embodiment of the search interface shown in FIG. 6, customized to perform searches of cable systems.

FIG. 10 illustrates a category interface of the interfaces shown in FIG. 3, customized to perform filtering of data representative of DMA's.

FIG. 11 illustrates another embodiment of the category interface shown in FIG. 10, customized to perform filtering of data representative of media platforms.

FIG. 12 illustrates another embodiment of the category interface shown in FIG. 10, customized to perform filtering of data representative of media programs.

FIG. 13 illustrates another embodiment of the category interface shown in FIG. 10, customized to perform filtering of data representative of cable systems.

FIG. 14 illustrates a media-content interface of the interfaces shown in FIG. 1 for presenting data representative of a DMA.

FIG. 15 illustrates another embodiment of the media-content interface shown in FIG. 14 for presenting data representative of a media platform.

FIG. 16 illustrates another embodiment of the media-content interface shown in FIG. 14 for presenting data representative of a media program.

FIG. 17 illustrates another embodiment of the media-content interface shown in FIG. 14 for presenting data representative of a cable system.

FIG. 18 illustrates another embodiment of the media-content interface shown in FIG. 14 for presenting data representative of an actor.

FIG. 19 illustrates another embodiment of the media-content interface shown in FIG. 14 for presenting data representative of a media genre.

FIG. 20 illustrates an exemplary design of a computer architecture used to support the embodiment of FIG. 1.

### DETAILED DESCRIPTION OF ILLUSTRATIVE EMBODIMENTS

The invention, in various embodiments, provides, among other things, systems and methods for interactive data finding of media-purchasing opportunities across a variety of media delivery systems, media platforms and geographical locations. The following detailed description of the invention refers to the accompanying drawings. The following detailed description does not limit the invention, and the various embodiments set out below and depicted in the figures are merely provided for the purposes of illustrating certain embodiments of these systems and methods and for describing examples of such systems and methods. However, it will be apparent to those of skill in the art that the systems and methods described herein may, in certain forms, be employed for interactive data finding for media purchasing across cable and network radio programming and for other applications. Thus, the scope of the invention is at least the scope defined by the appended claims and equivalents.

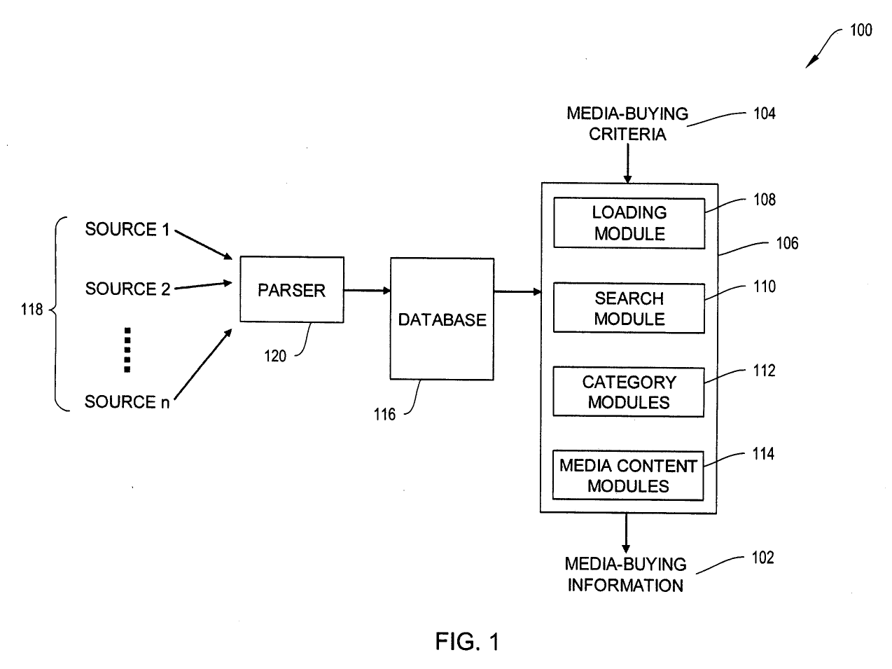

FIG. 1 illustrates a high-level block diagram of an interactive data finder 100, according to an illustrative embodiment of the invention. The data finder 100 determines target media-buying information 102 based on a set of media-buying criteria 104 supplied by a client of the data finder 100. The data finder 100 determines such media-buying information 102 by querying, at various levels of data abstraction, a database 116 that is coupled to a front-end component 106 of the data finder 100. The resulting media-buying information 102 is adapted to reveal to the client at least one media-buying opportunity associated with demographics, subscriber and program information pertinent to the media-buying opportunity. More specifically, this determination is accomplished via the combined operation of multiple functional modules of the front-end component 106, including a loading module 108, a search module 110, a category module 112 and a media content module 114. Each of the functional modules conducts searches of the database 116 at a designated drill-down level or in a specific data category using at least one of the media-buying criteria 104 to facilitate the searches.

The database 116 of the data finder 100 is further coupled to a variety of media sources 108 for supplying raw input data to the database 116 from which the media-buying information 102 is subsequently determined. The media sources 108 are, for example, Tribune Media Services, Federal Communications Commission, and Acxiom Corporation. Each media source 108 is only able to supply data having, at most, two of the three industry-standard media information types. These industry-standard information types include subscriber information, demographics information, and Program Guide information. By combining data from the variety of media sources 108, the data finder 100 of the present invention is able to acquire the most complete and up-to-date information that encompasses all three information types. Furthermore, the data finder 100 includes a data parsing structure 120 that corrects and parses the raw input data to enable more accurate data classification as well as more granular data categorization than the input data. Hence the data after being processed by the parsing structure 120 is adapted to reveal more details about the targeted media-buying information 102 than the raw input data from any one of the media sources 108. Details of the various components of the data finder 100 will be described below.

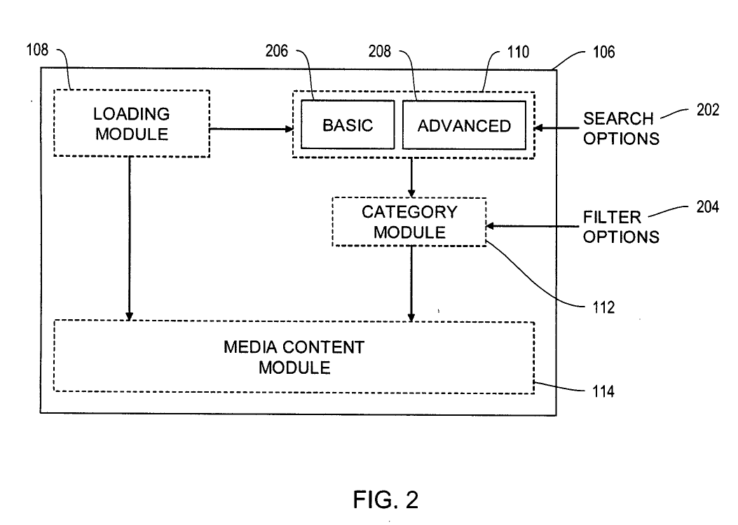

FIG. 2 provides a block diagram 200 of an illustrative front-end component 106 of the data finder 100. In particular, the loading module 108 of the front-end component 106 presents customizable media content that is of potential interest to a client of the data finder 100. Hence, this facilitates the efficiency with which desired media-buying information 102 may be accessed by the client. The search module 110, accessible from the loading module 108, allows the client to perform systematic and targeted searches of data in the database 116 by selecting one or more search options 202 associated with the search module 110. The search module 110 further includes a basic search engine 206 and an advanced search engine 208 for offering multiple drill-down options to the client. A category module 112 is introduced to present results of the search module 110 along with one or more user-selectable filter options 204 for refining the search results. A media-content module 114 is further accessible from at least one of the category module 112 and the loading module 108 for presenting detailed information related to a particular media-buying opportunity referenced in a search result or filter result of the category module 112, or in the media content of the loading module 108.

According to one embodiment of the present invention, search options 202 of the search module 110 are customized to obtain data representative of desired media-buying opportunities in a specific media-buying category. Exemplary categories include media program category, media platform category, cable system category and designated market area (DMA) category having data representative of media programs, media platforms, cable systems and DMA's, respectively. The search options 202 may thus be suitably customized to enhance the effectiveness of data searches in each of the categories. Data determined from the search module 110 is subsequently present in the category module 112, where the user-selectable filter options 204 provided therein are tailored to the data for offering customized data refinement.

The data finder 100 supports even further information drill-down. In particular, a client is able to access detailed information regarding a specific media-buying opportunity referenced in a search or filter result of the category module 112 or in the media content of the loading module 108. A media-buying opportunity is one of a media program, a media platform, a cable system, a DMA, an actor, and a program genre. In certain examples, detailed information about a media-buying opportunity includes a composite of data from Program Guide, subscriber and demographics and is culled from the database based on its relevance to the media-buying opportunity. In certain examples, the detailed information representative of the media-buying opportunity is presented in a media-content module 114 of the data finder 100. In certain examples, the media content module 114 includes links to other media content modules 114 for providing enhanced access to detailed information about media-buying opportunities that are inter-related.

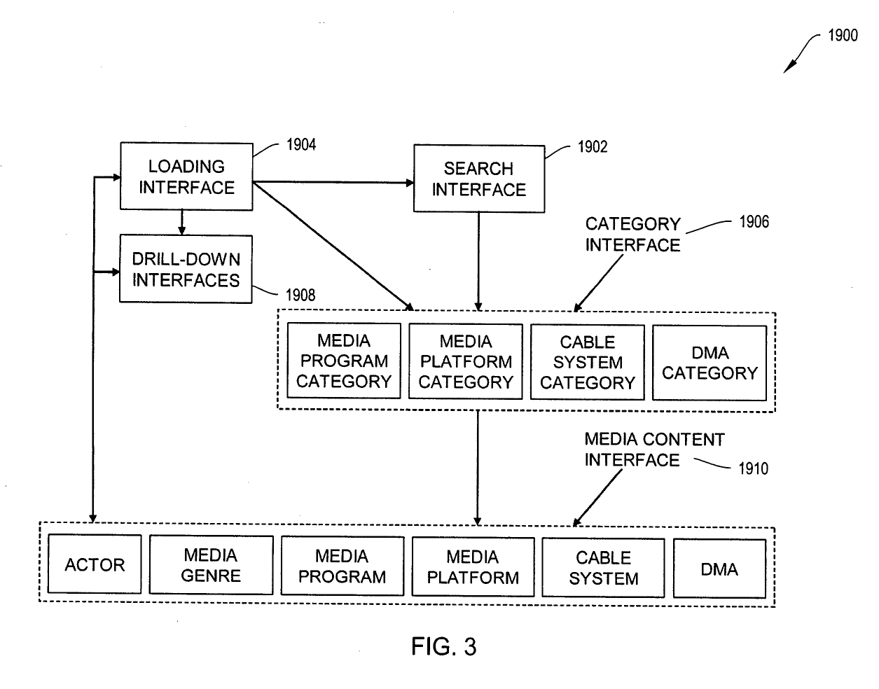

In one embodiment, the various functional modules of the front-end component 106 are made available to the client via multiple web-based interfaces of the data finder 100. The organization of the interfaces is such that it supports an intuitive approach to data retrieval. FIG. 3 shows an illustrative data cross-referencing path 1900 among the various interfaces of the data finder 100. In a top-down approach, a client is first presented with a landing interface 1904 that includes the loading module 108 as well access to the basic search engine 206 of the search module 110 for performing basic media-buying information queries. In addition, the landing interface 1904 provides the client access to one or more drill-down interfaces 1908 that display additional data related to the media content in the landing interface 1904. For example, the drill-down interfaces 1908 permit the client to obtain media content, order according to a certain ranking criterion, that is expanded from the media content displayed in the landing interface 1904. Moreover, the client is able to access a search interface 1902 of the data finder from the landing interface 1904 to perform search-option driven, advanced data queries via the advanced search engine 208 of the search module 110. Search results, whether determined from the basic or advanced search engines, are presented in a category interface 1906 for further drill-down from the category module 112 presented therein. Several configurations of the category interface 1906 are possible, depending on the data category under which the searches were conducted. In addition, filter options 204 are provided via the category interface 1906 to iteratively refine the search results.

From any one of the loading 1904, drill-down 1908, and category 1906 interfaces, the client is able to retrieve detailed information regarding any particular media-buying opportunity referenced therein. The detailed information is presented in a media-content interface 1910 of the data finder 100 which incorporates the media-content module 114 corresponding to the particular media-buying opportunity. In addition, from each media-content interface 1910, the client is able to directly access other media content interfaces 1910 to obtain detailed information regarding those media-buying opportunities related to the media-buying opportunity defined by the parent media-content interface 1910. Hence the client is presented with facilitated access to granular information regarding any media-buying opportunities of inter-relating dependence.

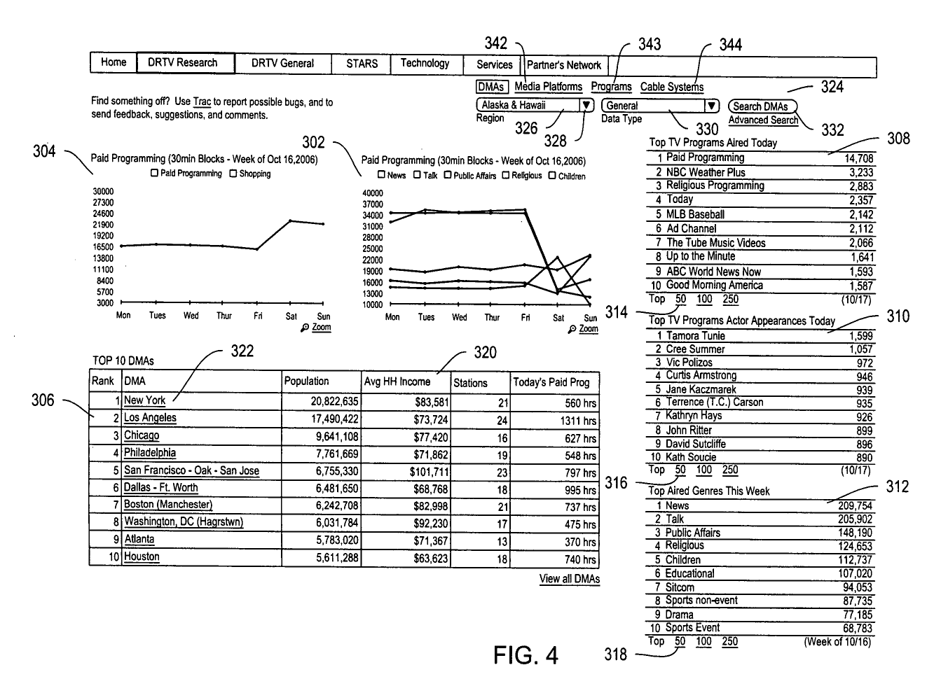

The landing interface 1904, search interface 1902, drill-down interface 1908, category interface 1906 and media content interface 1910 described above in FIG. 3 will be described below in greater detail with references to FIGS. 4-16.

FIG. 4 provides an illustrative landing interface 300 of the data finder 100 from which a client is able to access the loading module 108. The landing interface 300 is adapted to provide a graph having multiple plots displayed therein for illustrating trends in program airtime during a certain time period. Each plot further correlates to media programs having a shared characteristic such as a common program genre or a common programming type. Programming types, for example, classify programs into regular programming, shopping programming, and regular paid programming. In particular, graph 304 of FIG. 4 provides plots of total airtime dedicated to paid programming and shopping programming during the week of October 16. More specifically, graph 302 provides five plots of airtime corresponding to programs in five media genres that are highest ranked for the week of Oct. 23, 2006. These top five genres include News, Talk, Public affairs, Religion, and Children.

In certain implementations, the plots of graphs 302 and 304 are color-coded to assist the client in distinguishing between different airtime trends represented by the various plots. The client may also personalize plot colors to make the airtime trends more observable. In certain implementations, the program airtime is tracked in half-hour time blocks. For example, plots of graph 302 represent the number of half-hour time blocks assigned to media programs in each of the five top-ranked genres over the week of Oct. 23, 2006. However, other program airtime units are possible. For example, program airtime may be counted in minute increments, hour increments, or by the total number of times the media programs have aired regardless of the actual duration of each airing. In certain implementations, the client is able to adjust the time period for which a plot is generated to, for example, a month, a year, or any date range chosen by the user. Furthermore, the client may customize the criterion by which media programs are selected for plotting. For example, a graph may be customized to plot total airtime of programs in which top-five actors have made appearances in during the week of Oct. 16, 2006.

In another embodiment of the landing interface 300 of FIG. 4, selected data representative of media-buying opportunities is presented on the landing interface 300 and organized according to its respective category classifications. Furthermore, data in each category may be ranked according to a statistical measurement associated with all the data in that category. In particular, table 306 of FIG. 4 presents a listing of top ten DMA's associated with a particular calendar day. Each row of the table 306 identifies one of the top-ten DMA's along with multiple statistical information pertinent to the identified DMA. Each column of the table 306 provides a statistical field that characterizes all the top-ten DMA's. For instance, table 306 is able to provide the identities of the top-ten DMA's on Oct. 12, 2006 along with their population size, average household income of their subscriber population, the number of stations in the DMA's, and the number of hours these DMA's dedicate to airing programs of different programming types. Even though data for only the top ten DMA's are presented in table 306, this table 306 is user customizable to display any selected number of top-ranked DMA's and expandable to reveal a complete ranking of all the DMA's. In addition, it may be observed that the DMA's of table 306 are ranked in accordance to their population size. However, other ranking criteria are possible and are equally specifiable by the user. For example, by clicking on the column header 320 under “Avg HH Income,” the client is able to refresh table 306 to display top ten DMA's ranked by average household income of the subscriber population in each DMA. Hence, content of table 306 may change in response to a change of the ranking criterion. In certain instances, the user is able to customize data displayed in the table 306 by deleting or adding certain columns in order to view desired statistical information associated with the DMA's. For example, data fields may be added by the client to identify the number of High speed or DSL users in the subscriber population. Moreover, in certain instances, table 306 is able to provide prioritized media content in categories other than the DMA category. Hence, the criterion according to which the data in table 306 is ranked may not be the same as the criterion used to rank the DMA's. Table 306 is able to display, for example, a list of top ten media platforms ranked by the number of subscribers for each platform.

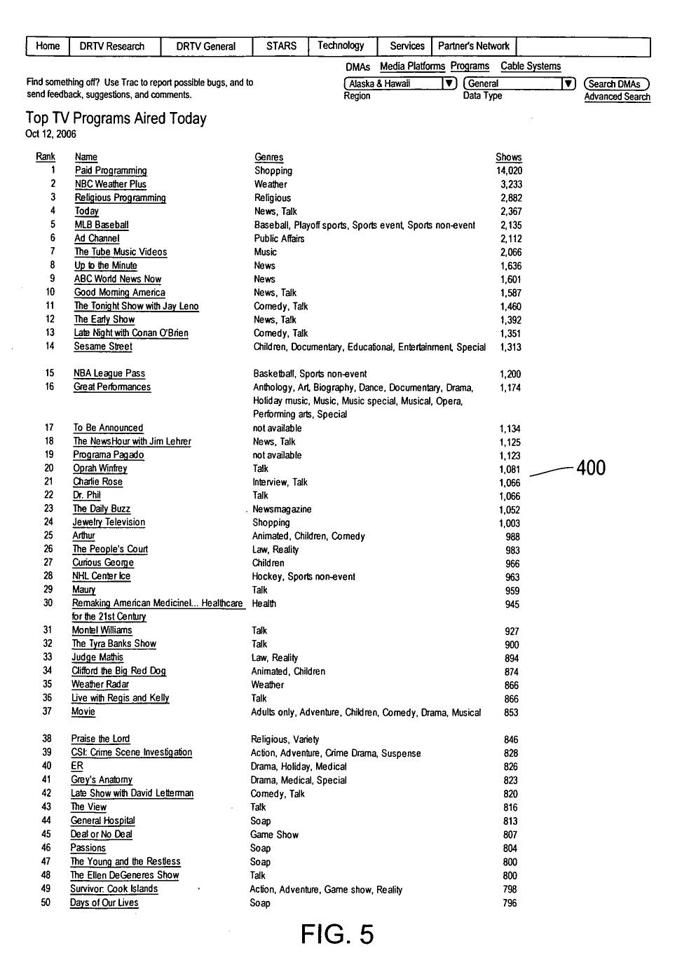

In certain implementations, a table 308 is provided via the landing interface 300 to present a list of top ten TV programs aired on a given day and ordered by their respective program airtime. Table 310 displays a list of top ten TV actor appearances ranked by airtime of the media programs in which each actor appeared. Table 312 shows a list of top ten aired media genres sorted by airtime of the media programs in the respective genres. In one example, expanded versions of lists 308, 310 and 312 are displayable from their respective drill-down interfaces. Each expanded list, provided in a drill-down interface, shows more prioritized media content than the content offered on the landing interface 300. For example, by activating link 314 of the landing interface 300, a client is presented with a drill-down interface 400, as shown in FIG. 5, that shows a listing of top fifty TV programs expanded from the abridged top-ten TV program list 308 of the landing interface 300. Similarly, lists of top fifty TV actor appearances and top fifty aired media genres associated with a given day are viewable from their corresponding drill-down interfaces by activating exemplary links 316 and 318, respectively. However, it is also possible that the expanded rankings are viewable in place from the landing interface 300. It is also possible to display other ordered listings, such as a list of top platforms ordered by the number of subscribers of each platform, a list of top DMA's order by their population size, or a list of top cable systems ordered by the number of DMA's covered by each system.

Moreover, in certain embodiments, detailed information regarding a media-buying opportunity revealed from the landing 300 or drill-down 400 interfaces of the data finder 100 is accessible from a media-content module 114 that includes data representative of the media-buying opportunity. As described above, a media-buying opportunity comprises, for example, a media program, a media platform, a media genre, an actor, a DMA or a cable system. In some instances, a media-content module 114 is provided in a separate media-content interface. In some instances, this drill-down capability is enabled by a hyperlink that connects a reference of the media-buying opportunity on the landing 300 or drill-down 400 interfaces to its corresponding media-content interface. For example, by selecting hyperlink 322 that references the “New York” DMA in table 306, the user is able to access a media-content interface that includes granular data pertinent to the New York DMA. Details of the media-content module 114 in relation to the media-content interface will be described below.

Furthermore, in certain embodiments of the landing interface 300 of FIG. 4, a client is able to access a basic search engine 206 of the search module 110 from the landing interface 300. This basic search engine 206 operates by querying the database 116 in search of data belonging to a specific data category and satisfies the criteria set forth in the basic search options of the category search. For example, the client is able to access the basic search engine via search area 324 of the landing interface 300. In particular, FIG. 4 illustrates an instance where a search for data in the DMA category is performed. Field 326 allows the client to specify a certain geographical region, such as Alaska and Hawaii, from a pull-down menu 328 of the basic search area 324. In other implementations, the client may supply this location by entering a term or a combination of terms in field 326 and using one or more Boolean logic operators to capture a relationship among the terms being searched. Moreover, the client is able to specify a viewing type 330 for displaying the search results determined from the basic search. These viewing types include General, Income and Age, where each type is associated with a pre-determined set of statistical fields displayable with each DMA identified from the basic search. Details regarding these viewing types will be explained below. Access to basic search of data in other data categories is provided from hyperlinks 342-344. In certain examples, a separate basic search interface is retrievable by the client to provide a dedicated access to the basic search engine 206.

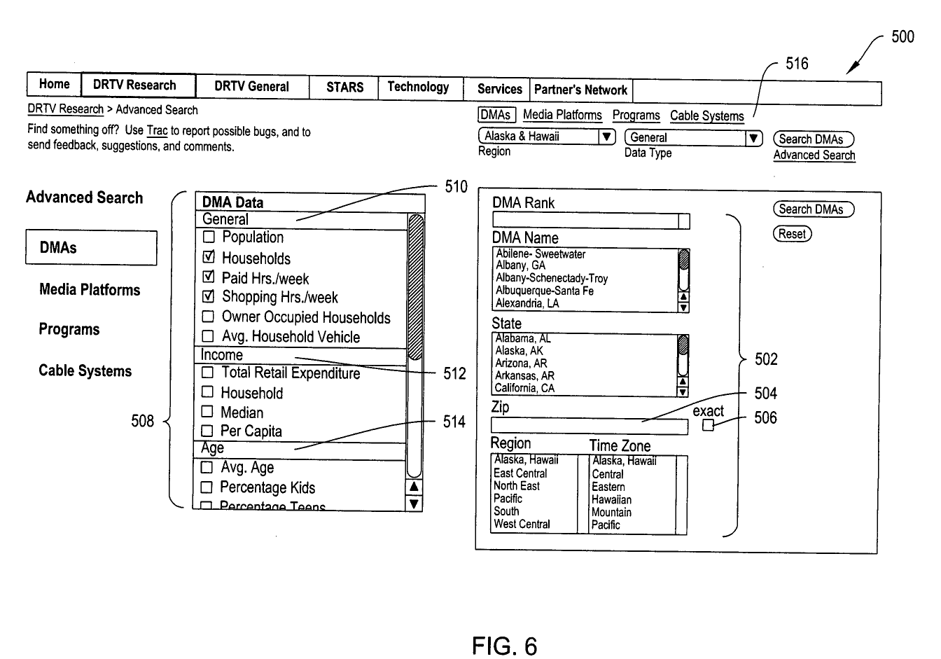

Another feature of the search module 110 includes an advanced search engine 208 available from a search interface of the data finder 100. This advanced search engine permits in-depth query of data that belongs to a particular data category. Various embodiments of a search interface are illustrated in FIGS. 6-9. In general, a search interface is presented to a client via activation of an advanced search link 332 on the landing interface 300. In some instances, the search interface includes tabbed regions for providing different sets of advanced search options available for selection by the client to perform category-specific search. Search results are thus dependent on the client's category selection as well as the search option selection within each of the category selection.

An exemplary search interface 500 is illustrated in FIG. 6. It provides to the client a set of search options 502 conducive to the determination of data representative of DMA's. In particular, each search option 502 allows the client to specify a desirable characteristic of the DMA's being searched. The search options 502 permit the client to specify, for example, a rank, a name, a State, a zip code, a region and a time zone associated with the targeted DMA's. In certain implementations, a specific criterion for a search option is selectable from a pull-down menu of that search option. In certain implementations, a user inputs the criterion into a text field associated with the search option, such as zip field 504 of the search options 502. In the case of manual data entry, the client is also given the opportunity to check an “exact” box 508 next to the text field 504 to decide whether the search should be conducted using the exact text supplied in the field. If the “exact” box 506 remains unchecked, the DMA's deemed to satisfy a criterion that has the user-supplied text contained within its overall descriptive text is also identified by the search. For example, when “2011” is entered in the zip field 504, all the DMA's having zip codes that contain the string “2011” are determined from the search, including, for example 20114, Boston. In other implementations, if the “exact” box 506 is not checked, the DMA's deemed to satisfy an approximate version of the criterion in the text field are identified in the case that the exact criterion cannot be satisfied from the search.

A set of viewing options 508 is additionally presented to the client that allows the client to specify certain statistical information that would appear with the identified DMA's from the advanced search. These viewing options 508 are categorized, for example, into three types including General 510, Income 512, and Age 514. Viewing options under the General viewing type 510 allow the user to select for display generalized statistical information about the DMA's. Similarly, viewing options under the Income viewing type 512 and Age viewing type 514 allow the user to select for display income- and age-related statistics, respectively, of the subscriber population in the DMA's identified from the advanced search. In certain examples of the search interface 500, a user is again given the opportunity to perform basic DMA searches from a basic DMA search area 516 of the interface 500. This basic search area 516 may be substantially same as the basic search area 324 presented in the landing interface 300.

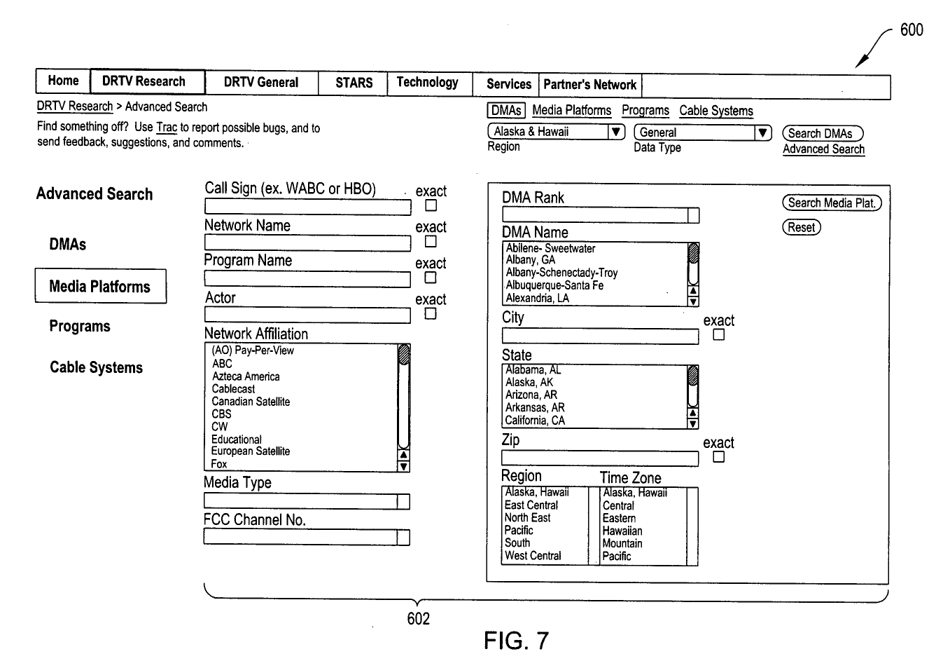

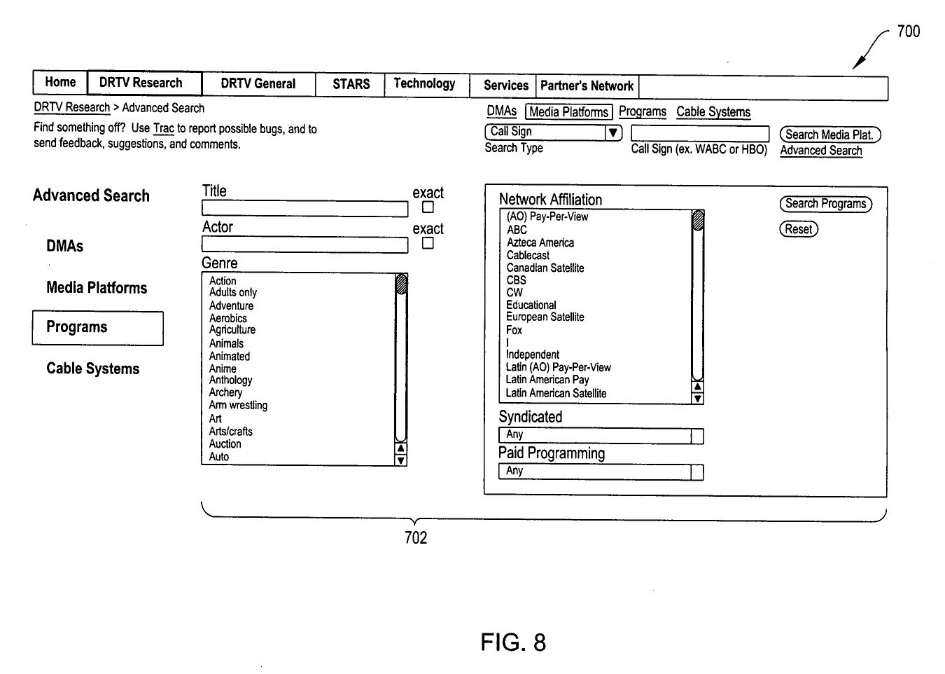

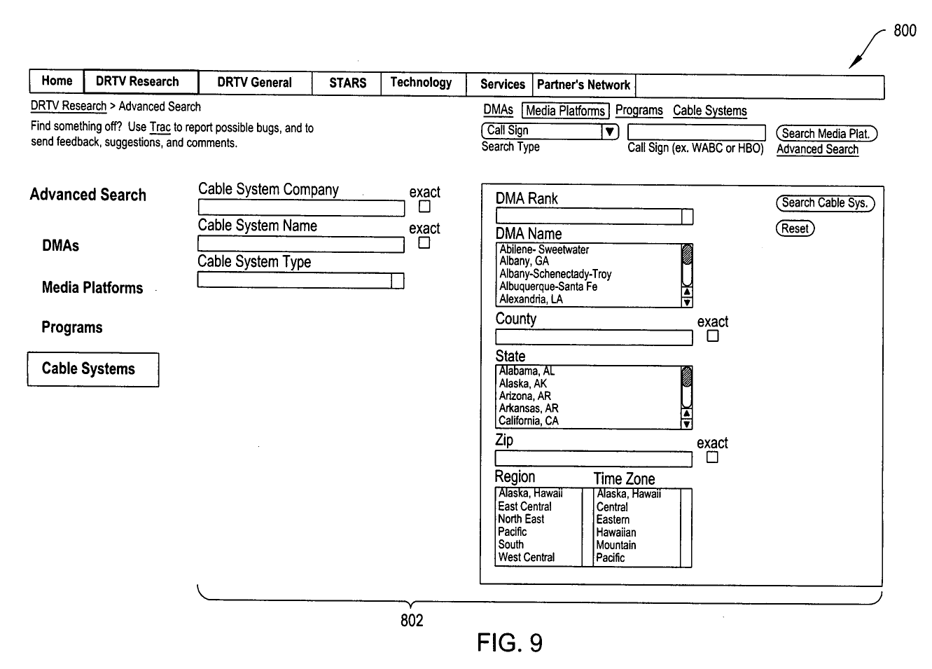

FIG. 7 shows an illustrative embodiment of a search interface 600 that provides a set of search options 602 customized to deliver data representative of media platforms. These search options allow the user to specify, for example, a DMA rank, a DMA name, a city, a state, a zip code, a call sign, a network name, a program name, an actor, a network affiliation, and a FCC channel number of the media platforms being searched. Furthermore, FIGS. 8 and 9 present illustrative embodiments of search interfaces 700 and 800 tailored for conducting advanced searches of desired media programs and cable systems, respectively. In particular, the advanced search options 702 for determining media program information let the client to specify a network affiliation, a syndication criterion, a paid programming type, a program title, an actor, and a program genre related to the targeted media programs. The advanced search options 704 corresponding to the cable system search let the client to specify a DMA rank, a DMA name, a country, a state, a zip code, a region, a time zone, a cable system company name, a cable system name and a cable system type of the desired cable systems.

In general, search interfaces 600, 700, and 800 may also include viewing options selectable by the client to specify, for display, statistical information of interest regarding the media-buying opportunities identified from the respective search interfaces. Moreover, for all the illustrative search interfaces as described above, instead of presenting selectable search options, a Boolean search field may be presented to provide the client with the opportunity of entering a text string for search, where the text string may have a mix of search criteria as well as a mix of Boolean operators to define a relationship among the search criteria. The search string may also indicate one or more of the categories from which data should be determined. Consequently, only one search interface becomes necessary for conducting queries of data simultaneously satisfying multiple data categories.

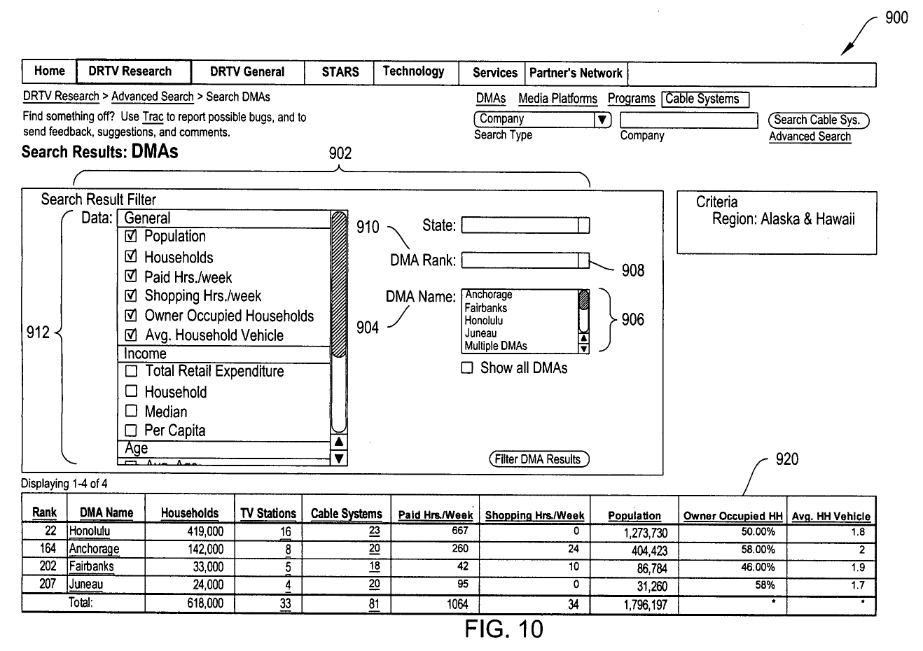

Search results from the basic 206 or the advanced 208 search engines of the search module 110 are provided in a category module 112 of the data finder 100 for review by the client. The category module 112 is made available to the client from a category interface whose various embodiments are shown in FIGS. 10-13. In addition to presenting results obtained from the search engines, the category interface also displays a set of filter options customized for facilitating the selective refinement of the search results. Hence, data shown via the category interface is adapted to change in response to each unique selection of the filter options presented therein.

In particular, FIG. 10 provides an illustrative embodiment of a category interface 900 that is configured to display data representative of DMA's, as acquired from either a basic or an advance DMA search engine. This data is presented in a table 920 of the interface 900 which shows pertinent DMA statistical information for each of the identified DMA's. The statistical information may be selected from the viewing options 508 of the DMA search interface 500, as described above with respect to FIG. 6. Data in table 920 is filterable based on a selection of filter options 902 provided via the category interface 900. The filter options 902 include, for example, a state, a DMA rank and a DMA name. In general, each filter option 902 is such that it only presents to a user for selection those criteria that are likely to refine the search results. That is, the data finder 100 is intelligent enough to eliminate from the filter options 902 those criteria that would not alter the search results in any way. For example, in the “DMA name” filter option 904, only the names of DMA's that are already in the search results are made available by the data finder 100 as selectable criteria in the pull-down menu 906 of the filter option 904. In addition, the pull-down menu 908 of the “DMA rank” filter option 910 is likely to present to the client for selection only the four rank numbers associated with the search results of table 920. In certain implementations, the content and organization of the table 920 is generally customizable by the client. For example, by selecting or de-selecting one or more of the viewing options 912 in the category interface 900, the user is able to eliminate or add statistical fields to the result table 920 to personalize the information displayed therein regarding each of the DMA's. More specifically, in addition to the “households,” “paid hours/week,” and “shopping hrs/week” fields that are already displayed, as stipulated by the viewing options 508 of the search interface 500 in FIG. 6, the user is also able to select additional DMA-related data fields, such as “population,” “owner occupied households,” and “High speed/DSL users,” for display from viewing options 912.

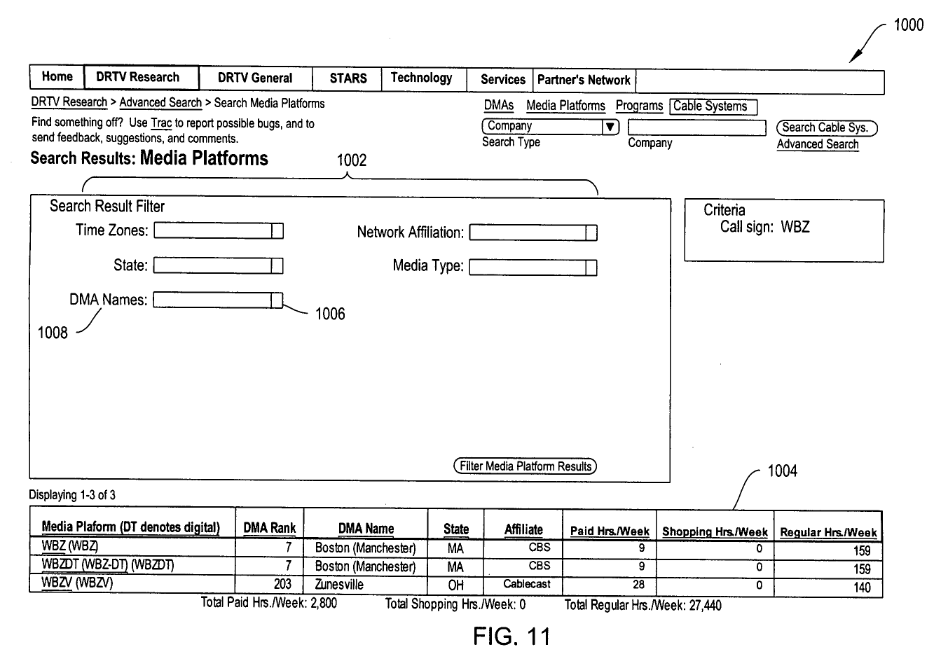

FIG. 11 provides another embodiment 1000 of a category interface that provides, via table 1004, search results representative of media platforms, where the search results are obtained from either a basic or an advanced search engine of the search module. As shown in the table 1004, the data displayed reveals a DMA rank, a state, an affiliation, and program airtime associated with identified DMA's. In addition, data in this table 1004 is adapted to change with a specific selection of a set of filter options 1002 that are tailored the data. Possible filter options 1002 include, for example, a media type, a network affiliation, a DMA name, a state and a time zone associated with the media platforms being refined. Moreover, each of the filter options 1002 that has a pull-down menu only presents to the client for selection those criteria that would likely refine the results in table 1004. For example, the pull-down menu 1006 of a “DMA name” filter option 1008 is likely to display only the names of the DMA that are shown in table 1004.

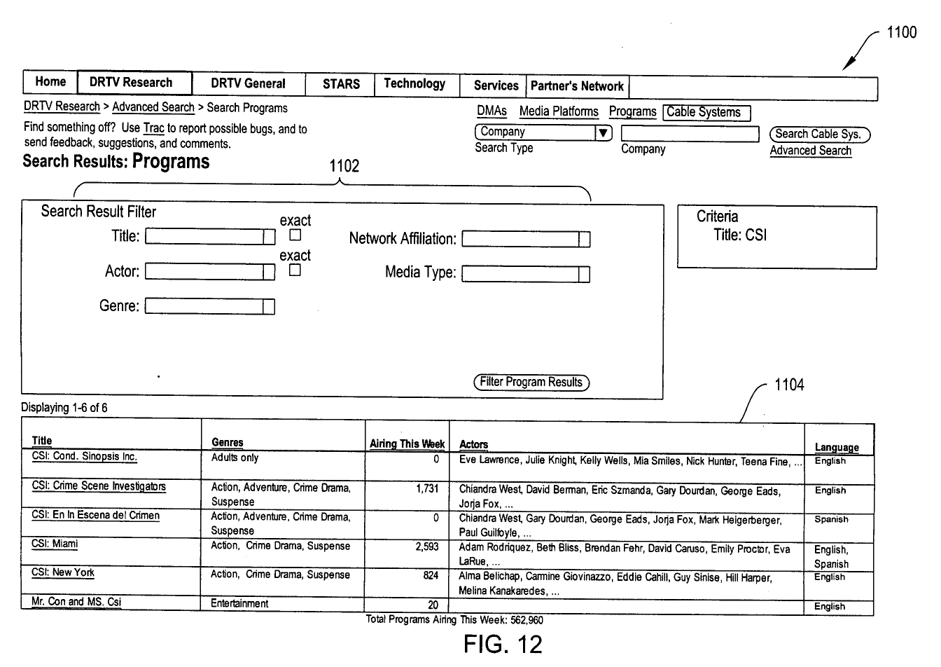

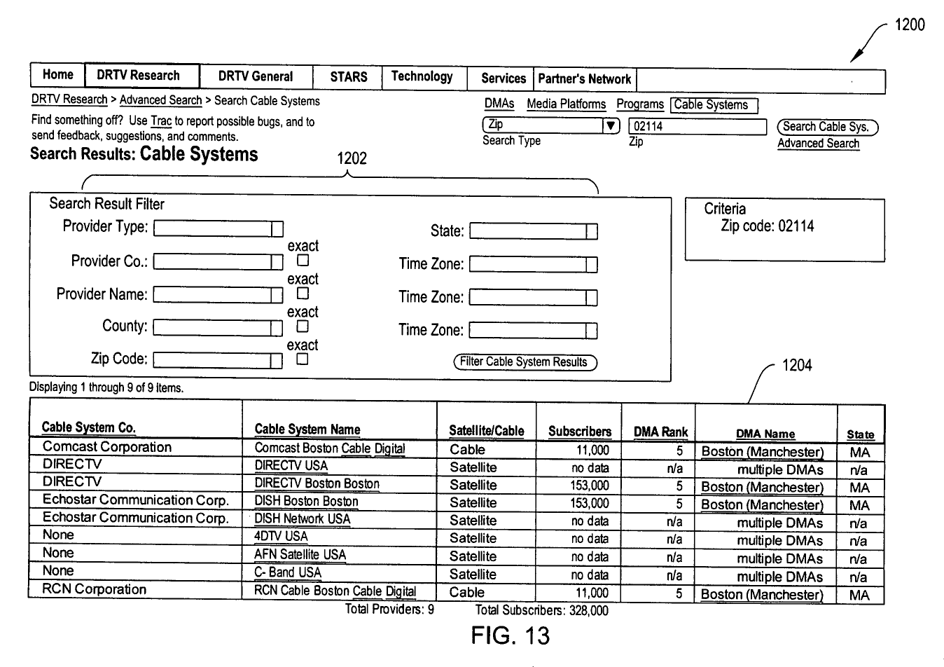

FIGS. 12 and 13 show illustrative embodiments 1100 and 1200 of category interfaces that include filter options 1102 and 1202 for refining data representative of media programs and cable systems, respectively. In particular, results presented in the table 1104 of the category interface 1100 displays statistics, such as program genre, number of times a program has aired, actors in a program and language of a program, for the media programs determined from the search module. In addition, this table 1104 is filterable by title, actor, genre, language, network affiliation and syndication requirement of the programs. For the category interface 1200 of FIG. 12, table 1204 is adapted to display cable system-related statistics for those systems identified from the search module. These statistics indicate whether each system is a cable or a satellite system, number of subscribers of the system, DMA rank of the system, and DMA name corresponding to the DMA rank. Furthermore, table 1204 is filterable by provider type, provider company name, county, zip code, state, time zone, DMA name and DMA rank of the identified cable systems.

In general, category interfaces 900, 1000, and 1200 may also include viewing options selectable by the client to specify, for display, statistical information of interest regarding the media-buying opportunities identified from the respective interfaces. Moreover, all the category interfaces are replaceable by a single interface that includes a Boolean search field for conducting advanced searches in all categories.

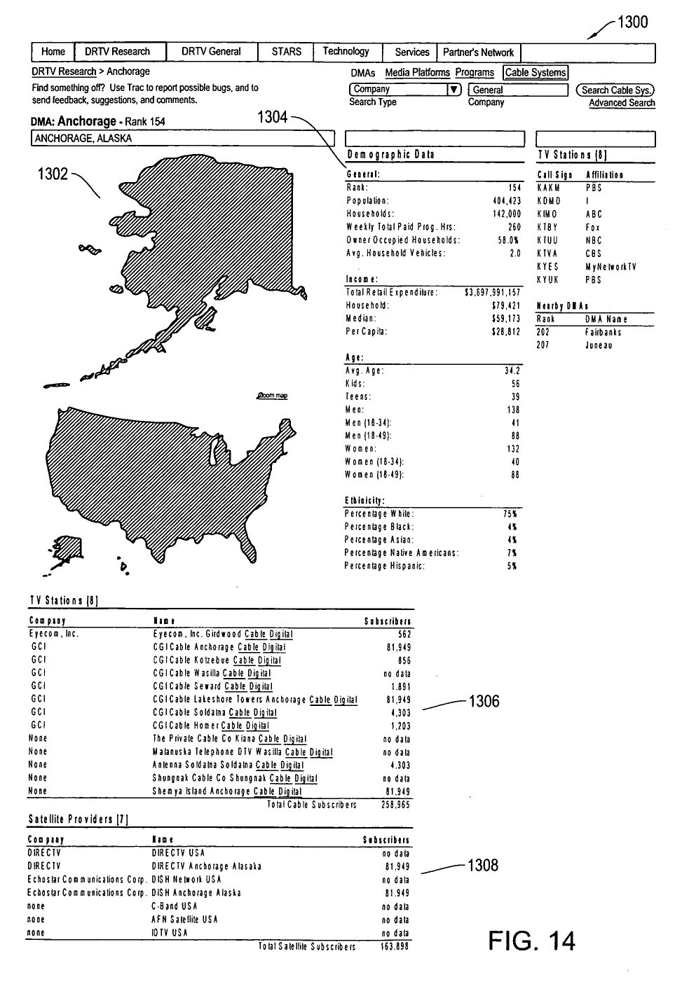

Another level of information drill-down is initiated by a client based on the client activating links underlining references to specific media-buying opportunities. These links are adapted to be present in any one of the loading 300, drill-down 400, and category interfaces of the data finder 100. As described above, each media-buying opportunity comprises, for example, a DMA, a media platform, a media program, a cable system, a program genre and an actor. Detailed information regarding a media-buying opportunity is presented in a media content module 114 made available from a media content interface of the data finder 100. FIGS. 14-19 show various illustrative embodiments of a media content interface.

In FIG. 14, a media content interface 1300 is provided that includes data representative of the Anchorage, Ak. DMA. This data is likely to be an aggregate of information culled from a variety of media sources and in a variety of data categories as well as including a blend of program, demographics and subscriber information related to the Anchorage DMA. According to FIG. 14, a map 1302 is presented to graphically illustrate the geographical location of the given DMA. This map may be zoomable, or otherwise customizable, by a client of the data finder 100. Demographics data pertinent to the Anchorage DMA is provided in table 1304 that additionally identifies those DMA that are near the Anchorage DMA. Furthermore, cable and satellite providers in the DMA are provided via respective listings 1306 and 1308 of the interface 1300 in terms of provider company association, provider name, and number of subscribers to each of the providers.

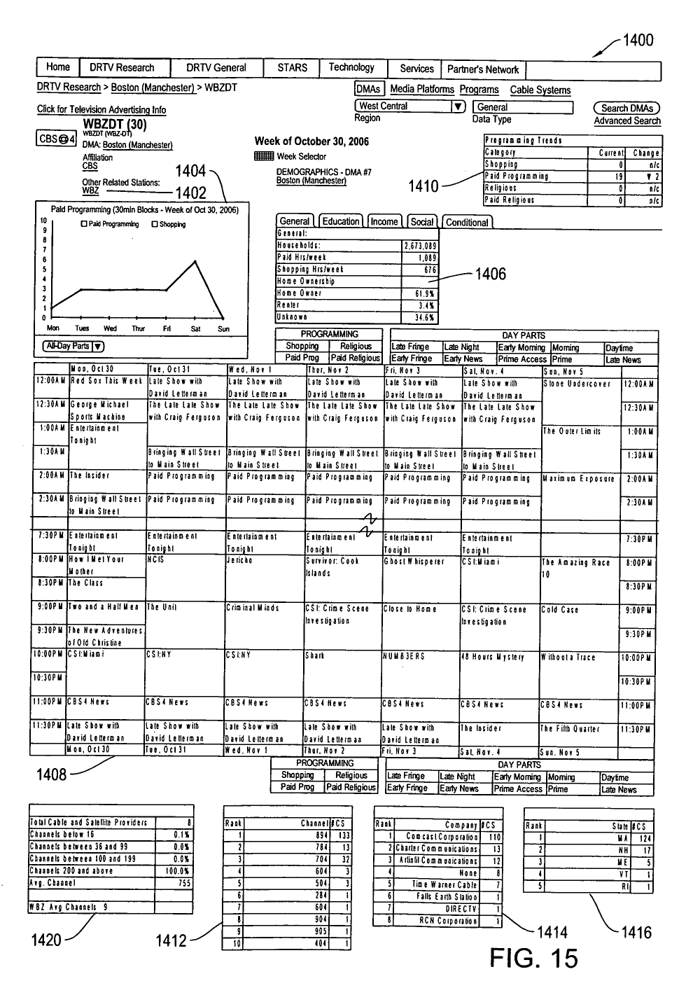

FIG. 15 shows an illustrative media content interface 1400 representative of the media platform WBZDT (30). Appropriate identification is made via the interface 1400 to indicate that WBZDT(30) is a digital data stream of a multiplexed channel WBZ, which is also identified from the activatible reference 1402. In certain examples, at least one graph 1404 is displayed via the interface 1400 that shows plots of media airtime, over a user-specifiable time period, for programs of various types aired on WBZDT(30). In some instances, demographics data associated with WBZDT(30) is provided on the media content interface 1400 in region 1406. In some implementations, a program schedule 1408 of WBZDT(30) is displayed. The program schedule 1408 is organized in a grid format with each row identifying a time block and each column identifying a calendar day. Hence, the combination of a row and a column specifies a program that is scheduled to be aired at a certain time indexed by the row and on a certain day indexed by the column. The time blocks may be color-coded by industry-standard day parts to indicate, for example, late night, early news, early morning, prime news, prime, morning, etc, This color-coding scheme enhances the efficiency with which a client is able to detect desirable media-buying opportunities from a quick examination of the program schedule. In certain examples, paid programming of the program guide is further distinguishable by types such as shopping programming, religious programming, regular paid programming and paid religious programming. In some examples, a decreasing, increasing or otherwise stable trend in airtime for paid programming of each type is indicated, such as by arrows 1410, based on comparisons of airtime to a previous time period. In certain examples, interface 1400 is also able to indicate trends in WBZDT(30) distribution among various geographical locations, analog and digital delivery systems, cable providers and subscribers of the platform. For instance, the top ten channels, top ten companies and top ten states carrying WBZDT(30) are listed in regions 1412, 1414, and 1416, respectively. In certain examples, top cable systems offering WBZDT(30) are also identifiable via the interface 1400.

In certain embodiments of the media content interface 1400, a distribution of WBZDT(30) among all channel positions is tracked and logged to reveal additional media-buying opportunities to the client. For instance, as shown in region 1420, WBZDT(30) is offered, 100% of the time, from channels 200 and above. Moreover, its average assigned channel position is 755. However, its sister channel WBZ has an average channel position of only 9. In the media advertising industry, those platforms occupying a lower channel position are typically more desirable to advertisement purchasers due to their enhanced frequency of access among the subscribers. Hence knowledge of channel positions allows the client to make well-informed media-purchasing decisions, for example, between channels WBZ and WBZDT(30). In yet another example, distribution of a media program aired on WBZDT(30) can be tracked across various channel positions, analog and digital delivery systems, and geographical locations. For example, the data finder 100 is able to detect if a show, having been airing on channel 10 of WBZDT(30) for the past two months, is now aired on channel 210. Based on this tracking result, the client may decide to reschedule his or her advertisement slot to air on the same channel and during the same time as the program.

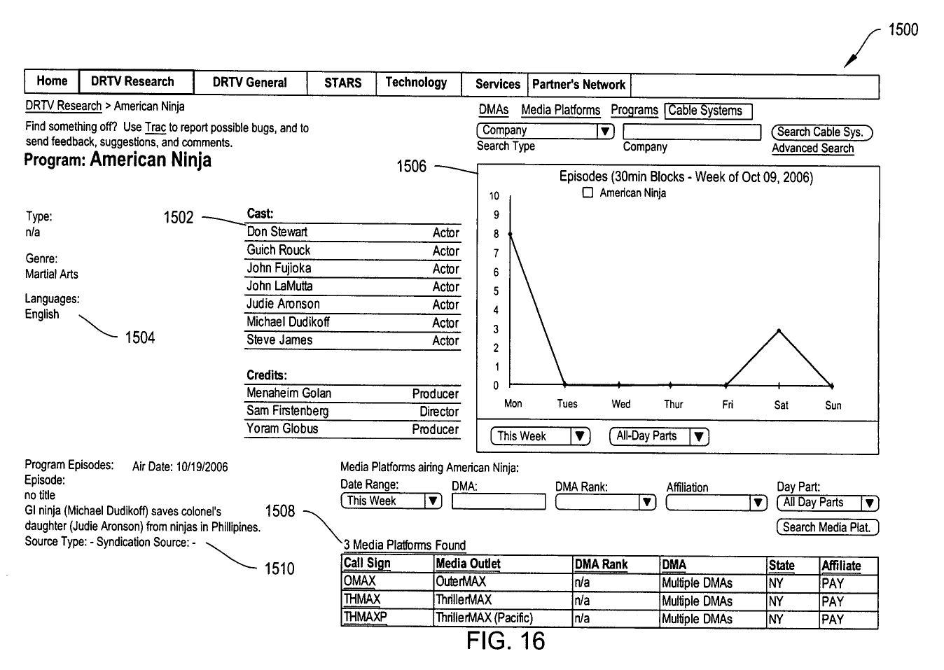

FIG. 16 shows an embodiment of a media-content interface 1500 representative of the media program “American Ninja.” From the media-content interface 1500, a client is able to view a list 1502 of cast members in “American Ninja.” The user is also able to find a program type, program genre, and languages associated with “American Ninja” in area 1504 of the interface 1500. In addition, at least one graph 1506 is provided to show a plot of the number of times “American Ninja” is aired in a given time period. It is equally feasible to provide a plot of program airtime for “American Ninja” over the given time period. This time period is user-adjustable to reveal a trend in program airtime for the current week, for a historical week, or for any other date range indicated by the user. Furthermore, media platforms airing “American Ninja” can be searched according to a time period, DMA, DMA rank, platform affiliation and day part. The results of such query are shown in a data table 1508 of the media-content interface 1500. In certain implementations, program episode information 1510, such as an episode description, is also displayed in the interface 1500.

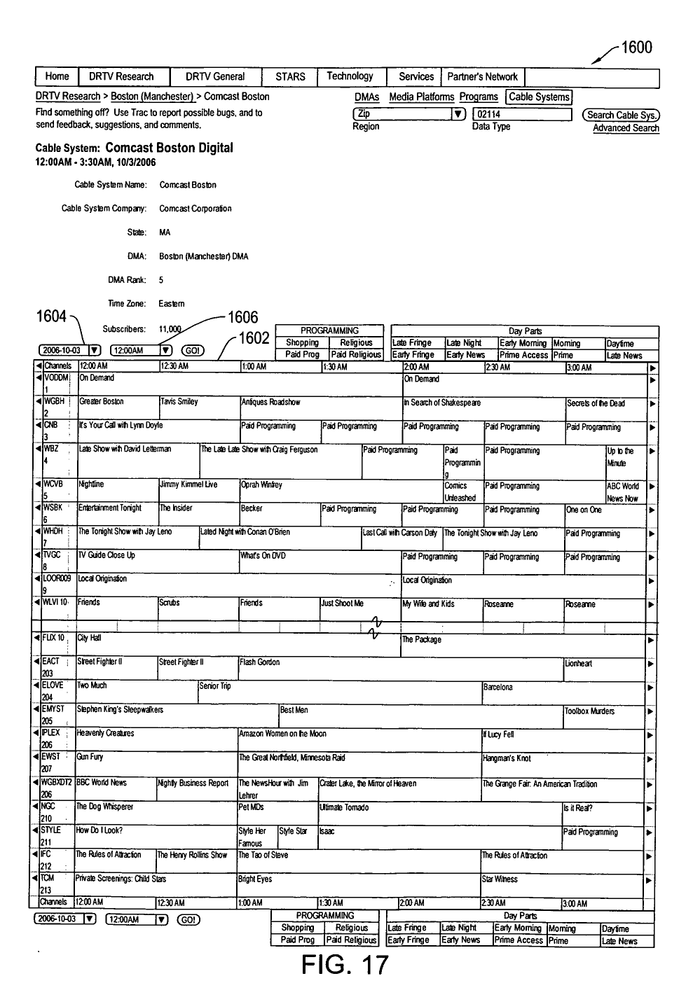

FIG. 17 provides an embodiment of a media-content interface 1600 representative of the cable system Comcast Boston Digital. In addition to providing demographics and subscriber information relevant to Comcast Boston Digital, a Program Guide schedule 1602 associated with the system is also presented. This Program Guide schedule includes rows identifying channels of the cable system and columns identifying times blocks in a calendar day. Color-coding schemes assigned to the various day parts and paid programming types of the program schedule 1408 in FIG. 15 are equally applicable to the program schedule 1602 for Comcast Boston Digital. In addition, this program schedule 1600 may be adjusted by the client as a function of both date 1604 and show time 1606.

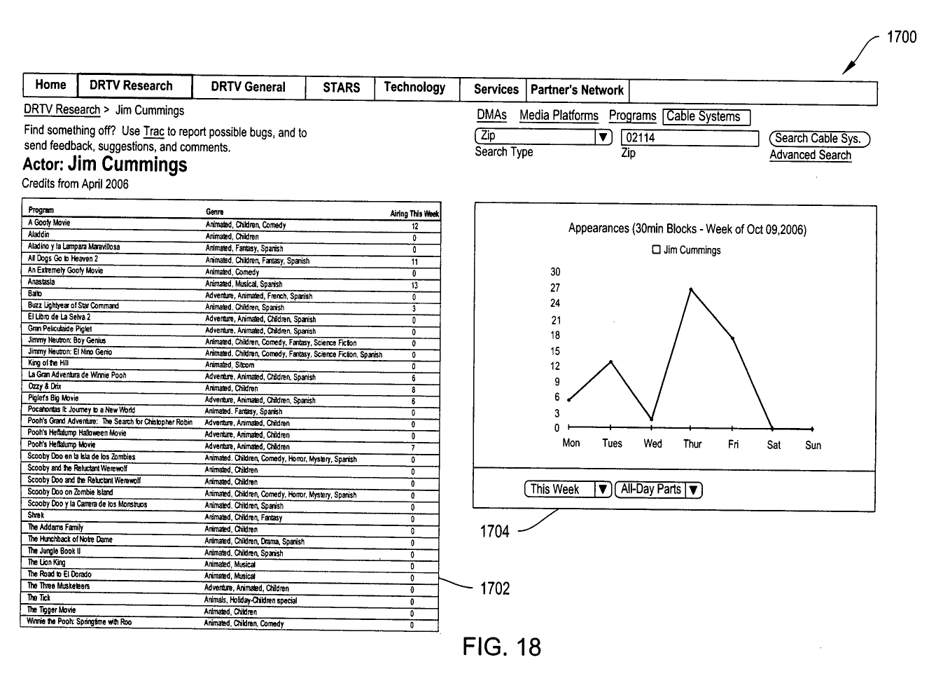

FIG. 18 provides an embodiment of a media-content interface 1700 for an actor, Jim Cummings. A list 1702 of media programs in which the actor has appeared in for a given time period is displayable via the media-content interface 1700 along with the programs' media genres and the number of times they were aired within the given time period. A customizable graph 1704 is also displayed, in some instances, to provide a plot of total airtime, over a selectable time period, associated with the media programs in which Jim Cummings has made an appearance.

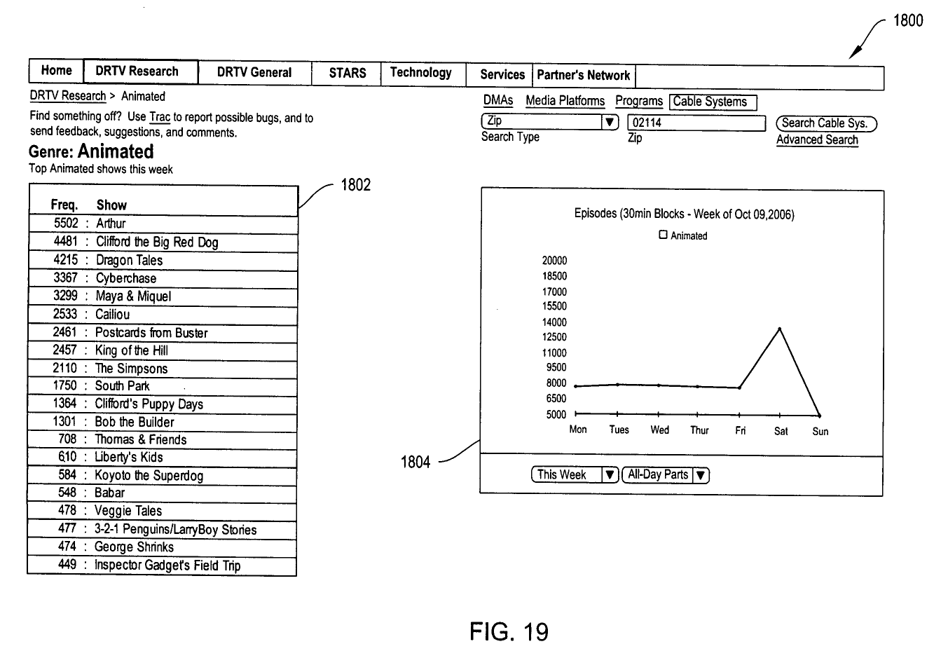

FIG. 19 provides an embodiment of a media-content interface 1800 representative of the media genre Animated. The interface 1800 shows a listing 1802 of top shows, belonging to the Animated genre, that were aired within a user-specifiable time period. In addition, at least one graph 1804 is presented to display a plot of airtime, over the given time period, dedicated to airing those programs belonging to the Animated genre.

In certain examples, from each media-content interface, the client is able to directly access other media content interfaces to obtain detailed information regarding those media-buying opportunities related to the media-buying opportunity defined by the parent media-content interface. Hence the client is presented with facilitated access to granular information regarding any media-buying opportunities of inter-relating dependence. For example, as shown in FIG. 14, the media-content interface 1300 representative of the Anchorage, Ak. DMA includes links to interfaces representative of those cable systems within the Anchorage area. If Comcast Boston Digital is one of the cable systems providing coverage in Anchorage, then the client is given the opportunity to obtain detailed information regarding this digital cable system by activating a link to its media-content interface 1600 via interface 1300. From the media-content interface 1600 representative of Comcast Boston Digital, as shown in FIG. 17, if the client sees, from the program schedule 1602, a show “American Ninja” that is of interest to him, the client is able to access the show's media-content interface 1500 via interface 1600. From the media-content interface 1500 representative of “American Ninja,” as illustrated in FIG. 16, if the client determines, from performing a media platform search, that the show is scheduled to air from the platform WBZ(4) this week, then information regarding WBZ(4) may be accessed by the client via table 1508 of the interface 1500. In addition, from the media content interface 1500 representative of the show “American Ninja,” the client is also able to access detailed actor information and program genre information regarding an actor and a program genre, respectively, of “American Ninja.”

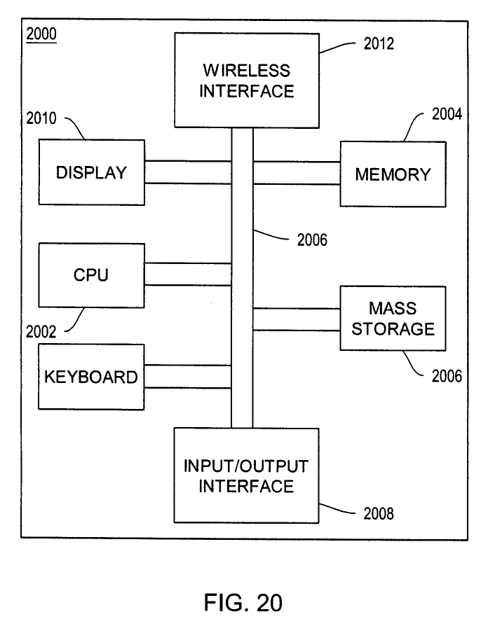

FIG. 20 shows a functional block diagram 2000 of a general purpose computer system for performing the functions of the data finder according to an illustrative embodiment of the invention. The exemplary computer system includes a central processing unit (CPU) 2002, a memory 2004, and an interconnect bus 2006. The CPU 2002 may include a single microprocessor or a plurality of microprocessors for configuring the computer system as a multi-processor system. The memory 2004 illustratively includes a main memory and a read-only memory. The computer 2000 also includes the mass storage 2006 device having, for example, various disk drives, tape drives, etc. The main memory also includes dynamic random access memory (DRAM) and high-speed cache memory. In operation, the main memory 2004 stores at least portions of instructions and data for execution by the CPU 2002. The mass storage 2006 may include one or more magnetic disk or tape drives or optical disk drives, for storing data and instructions for use by the CPU. At least one component of the mass storage system 2006, preferably in the form of a disk drive or tape drive, stores the databases used for processing the functions of the data finder of the invention. The mass storage system 2006 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 2000. The mass storage 2006 may support a database, such as database 116 depicted in FIG. 1. The database 116 can be any suitable database system, including the commercially available Microsoft Access database, or the Oracle database system and can be a local or distributed database system. The design and development of suitable database systems are described in McGovern et al., A Guide To Sybase and SQL Server, Addison-Wesley (1993). The database 116 can be supported by any suitable persistent data memory, such as a hard disk drive, RAID system, tape drive system, floppy diskette, or any other suitable system, and connect to the system over a network or bus as shown in FIG. 20.

The computer system 2000 may also include one or more input/output interfaces 2008 for communications via a network of the computer system. The input/output interface 2008 may be a modem, an Ethernet card or any other suitable data communications device. The input/output interface 2008 may provide a relatively high-speed link to the network, such as an intranet, internet, or the Internet, either directly or through an another external interface. The communication link to the network may be, for example, optical, wired, or wireless 2012 (e.g., via satellite or cellular network). Alternatively, the computer system may include a mainframe or other type of host computer system capable of Web-based communications via the network.

The computer system also includes suitable input/output ports or use the interconnect bus for interconnection with a local display 2010 and keyboard or the like serving as a local user interface for programming and/or data retrieval purposes. Alternatively, server operations personnel may interact with the system for controlling and/or programming the system from remote terminal devices via the network.

The computer system may run a variety of application programs and stores associated data in a database of mass storage system 2006. One or more such applications may enable the receipt and delivery of messages to enable operation as a server, for implementing server functions relating to the data finder 100 of the present invention. The components contained in the computer system 2000 are those typically found in general purpose computer systems used as servers, workstations, personal computers, network terminals, and the like. In fact, these components are intended to represent a broad category of such computer components that are well known in the art. Certain aspects of the invention may relate to the software elements, such as the executable code and database for the server functions of the data finder.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, having a computer readable program code stored thereon.

Again in reference to FIG. 1, The data finder 100 of the present invention also includes a data parsing structure 120 that automatically associates media-buying data supplied from the various external media sources 108 with the multiple levels and categories that are internal to the data finder 100. In certain implementations, this is achieved based on the data parsing structure 120 intelligently inserting unique identification tags into the raw data from the media sources 108 in order to match the data with its various classifications at various levels of data granularity. In certain implementations, the raw data supplied to the data finder 100 is not categorized and the data parsing structure 120 performs automatic data classification based on a name associated with each media content item transmitted. In certain implementations, the raw data may be categorized at a coarse-level, and the data parsing structure 120 is able to parse the coarsely-identified data into more granular categories that were not identifiable from the raw data. For example, data for paid programming may be further distinguished, within the data finder, according to various paid programming types such as shopping programming, regular paid programming, religious programming, and paid religious programming. In another example, the data parsing structure 108 is able to distinguish between the multiple data streams of a multiplexed channel. For example, in FIG. 15, WBZ(30) is identified as a digital stream transmission that is distinguishable from other streams such as WBZDT, both of which are transmitted via a common multiplexed channel, WBZ. In another example, platforms are separable into types such as analog, digital, Pacific-feed, Eastern-feed and other multi-feed media platforms. Moreover, the data parsing structure 120 is also able to detect errors in the raw data that prevent the data from being accurately categorized. In certain instances, if a misleading title is attributed to a program from its media source 108, the data parsing structure 120 is still able to categorize the program under its intended category. For example, a cable network show named “America's Collectables Network” is discernable by the parsing structure as a paid program for selling jewelry, and is classified as such.

The foregoing description of the preferred embodiment of the invention has been presented for the purposes of illustration and description. It is not intended to be exhaustive or to limit the invention to the precise form disclosed. Many modifications and variations are possible in light of the teaching herein.

What is claimed is:

1. An interactive data finder that allows an advertisement purchaser to associate media programs with demographics and subscriber information, comprising:
a search module for processing input data to determine data representative of media buying opportunities as a function of search options representative of media buying criteria, and
a category module for refining the data representative of the media buying opportunities as a function of filter options representative of media buying criteria related to the media buying opportunities,
wherein the refined data provides the advertisement purchaser with the information that associates the media-buying opportunities with at least one of the demographics and the subscriber information.

2. The interactive data finder of claim 1, further comprising a media-content module for presenting at least a portion of the refined data representative of one of the media buying opportunities.

3. The interactive data finder of claim 2, further comprising a data parsing structure for receiving the input data from at least one media source, identifying a plurality of categories for classifying the input data, and editing the input data to include information identifying the respective plurality of categories, wherein
the input data includes at least one of Program Guide information, subscriber information, and demographics information, and
the edited data is adapted to offer the advertisement purchaser more information about the plurality of media buying opportunities than the input data.

4. The interactive data finder of claim 3, wherein the plurality of categories comprise a designated market category that includes data representative of at least one designated market area, a media platform category that includes data representative of at least one media platform, a media program category that includes data representative of at least one media program, and a cable system category that includes data representative of at least one cable system.

5. The interactive data finder of claim 3, wherein the search module searches the input data in the plurality of categories by applying search options representative of at least one of the categories.

6. The interactive data finder of claim 3, wherein the category module refines the data representative of the media buying opportunities by applying filter options representative of at least one of the categories.

7. The interactive data finder of claim 3, wherein the at least a portion of the refined data representative of the media buying opportunity includes an aggregate of data from one or more of the plurality of categories.

8. The interactive data finder of claim 3, wherein the data parsing structure further comprises a tracking element for logging a movement of media content among at least one of channel positions, geographical locations, analog and digital subscribers, and analog and digital delivery systems identified from the input data.

9. The interactive data finder of claim 3, wherein the data parsing structure is adapted to extract data representative of paid programming from the input data and classifies the extracted data into types comprising a shopping programming type, a paid religious programming type, a religious programming type, and a regular paid programming type.

10. The interactive data finder of claim 3, wherein the data parsing structure is adapted to parse data in the plurality of categories into to a plurality of sub-categories associated with respective ones the categories, wherein
the data in the sub-categories is edited to include information related to the respective categories and sub-categories.

11. The interactive data finder of claim 10, wherein the data parsing structure parses data in the media platform category and classifies the parsed data into sub-categories representative of multi-feed media platforms including digital media platforms, analog media platforms, Pacific-feed media platforms, and Eastern-feed media platforms.

12. The interactive data finder of claim 2, wherein the media content module, provided from a media content interface of the data finder, is accessible from at least one of a category interface and a landing interface of the data finder, wherein
the category interface is adapted to provide the category module in connection with the plurality of filter options, and
the landing interface is adapted to provide at least a portion of the search module in connection with at least one of the search options.

13. The interactive data finder of claim 12, wherein the at least a portion of the search module includes a basic search engine of the search module, and
a second portion of the search module includes an advanced search engine provided from a search interface of the data finder.

14. The interactive data finder of claim 12, wherein the landing interface further comprises a graph module for presenting color-coded plots of a first portion of the input data and a table module for presenting a listing of a second portion of the input data, and
the first and second portions of the input data are functions of a time period selectable by the advertisement purchaser.

15. The interactive data finder of claim 14, wherein the graph module presents color-coded plots, over the selected time period, of program airtime associated with the first portion of the input data, wherein the first portion is categorized according to at least one of a program genre and a programming type.

16. The interactive data finder of claim 13, wherein the second portion is representative of a plurality of media buying opportunities sharing a media theme, and the listing provides an order of the second portion according to program airtime corresponding to the respective media buying opportunities represented by the second portion, wherein
the media theme comprises one of a designated market area theme, a TV actor appearance theme, a media program theme, and a media genre theme.

17. The interactive data finder of claim 13, wherein the category interface further displays the data representative of media buying opportunities determined from the search module, and
the data is adapted to change in real time in response to a selection of the plurality of filter options by the advertisement purchaser.

18. The interactive data finder of claim 13, wherein the search options and the filter options are tailored to the designated market area category and specify at least one of a geographical profile, a demographics profile, a rank, and a name associated with the designated area category.

19. The interactive data finder of claim 13, wherein the search options and the filter options are tailored to the media program category and specify at least one of a program profile, actor information, a network affiliation, a paid programming type, and a syndication criterion associated with the media program category.

20. The interactive data finder of claim 13, wherein the search options and the filter options are tailored to the media platform category and specify at least one of a call sign, a network affiliation, a type, a channel number, a program name, an actor, a geographical profile, and a designated market area profile associated with the media platform category.

21. The interactive data finder of claim 13, wherein the search options and the filter options are tailored to the cable system category and specify at least one of a cable system profile, a designated market area profile, and a geographical profile associated with the cable system category.

22. The interactive data finder of claim 13, wherein the at least a portion of the refined data representative of the media buying opportunity is a function of a time period customizable by the advertisement purchaser via the media content interface, and the
media buying opportunity relates to one of a designated market area, a media program, a media platform, a cable system, a program genre, and an actor appearance.

23. The interactive data finder of claim 22, wherein the media buying opportunity relates to the designated market area,
the corresponding media content module includes a customizable map showing at least a portion of the designated market area, and
the at least a portion of the refined data identifies at least one of a cable provider, a satellite provider and a media platform in the designated market area.

24. The interactive data finder of claim 22, wherein the media buying opportunity relates to the media platform,
the corresponding media content module includes a plurality of color-coded plots of program airtime in a plurality of paid programming categories of the media platform, and
the at least a portion of the refined data is organized in a program schedule format associated with the media platform.

25. The interactive data finder of claim 24, wherein the program schedule format includes a plurality of rows corresponding to a plurality of time blocks, a plurality of columns corresponding to a plurality of calendar days within the selected time period, and a plurality of cells each corresponding to a program scheduled in one of the times blocks and on one of the calendar days.

26. The interactive data finder of claim 25, wherein the time blocks are color-coded by day parts, and at least one of the program cells is color-coded according to a paid programming type of the program associated with the program cell.

27. The interactive data finder of claim 24, wherein the media content module further comprises an indicator element for indicating a trend in distribution for at least one of the media platform and a media program associated with the media platform among at least one of channel positions, geographical locations, analog and digital delivery systems, and analog and digital subscribers of the platform, and
the indicator element is adapted to indicate a trend in a number of times programs of a paid programming type are aired via the media platform.

28. The interactive data finder of claim 22, wherein the media buying opportunity relates to the media program,
the corresponding media content module includes a plot of a number of times the media program is aired within the selected time period, and
the at least a portion of the refined data is identifies a genre of the program, a language of the program, at least one actor in the program, at least one credit in the program, at least one episode of the program, and at least one media platform airing the program.

29. The interactive data finder of claim 22, wherein the media buying opportunity relates to the actor,
the corresponding media content module includes a plot of a number of appearances of the actor within the selected time period, and
the at least a portion of the refined data is associated with a media program featuring the actor that is aired within the time period.

30. The interactive data finder of claim 22, wherein the media buying opportunity relates to the program genre,
the at least a portion of the refined data is associated with a media program belonging to the program genre that is aired within the selected time period, and
the corresponding media content module includes a plot of a number of times the media program in the program genre is aired within the time period.

31. The interactive data finder of claim 22, wherein the media buying opportunity relates to a system,
the corresponding media content module includes a plurality of color-coded plots of program airtime in a plurality of paid programming categories of the system, and
the at least a portion of the refined data includes at least one of a program schedule, a number of subscribers, and at least one DMA associated with the system, wherein
the system comprises one of a cable system and a satellite system.

32. The interactive data finder of claim 31, wherein the program schedule includes a plurality of rows corresponding to channel positions and a plurality of columns corresponding to time blocks, wherein
the time blocks are color-coded to represent respective day parts and cells indexed by the rows and the columns are color-coded according to paid programming types of programs associated with the respective cells.

33. The interactive data finder of claim 22, further comprising a plurality of media-content interfaces having data representative of respective ones of a plurality of media buying opportunities, wherein
the media content interfaces are accessible from at least one of the loading and category interfaces, and at least a first of the media content interfaces is accessible from at least a second of the media content interfaces.
